(19) United States
(12) Patent Application Publication
(10) Pub. No.: US 2025/0341991 A1
(43) Pub. Date: Nov. 6, 2025

(54) CONTROL APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: Masafumi Inagaki, Kanagawa (JP)

(21) Appl. No.: 19/189,457

(22) Filed: Apr. 25, 2025

(30) Foreign Application Priority Data
May 1, 2024 (JP) 2024-074510

(51) Int. Cl. G06F 3/12

(52) U.S. Cl. CPC G06F 3/1208; G06F 3/1253

(57) ABSTRACT

A control apparatus, comprises a print control unit configured to cause a pattern image to be printed on a print medium with use of a first recording material for forming a three-dimensional image and a colored second recording material, the pattern image including a print region of the first recording material and a print region of the second recording material that overlap with, or are displaced from, each other, and a processing unit configured to execute processing for adjusting a displacement between a recording position of the first recording material and a recording position of the second recording material.

### BACKGROUND OF THE INVENTION

### Field of the Invention

The present invention relates to a technique to form a three-dimensional image.

### Description of the Related Art

Conventionally, there have been techniques to apply a foam accelerator ink to a surface of a medium equipped with a foam layer and heat the foam accelerator ink in an image forming apparatus that forms a three-dimensional image, thereby causing the area of the foam accelerator ink to foam, and realizing printing with stereoscopic effects. In a print apparatus of an inkjet type or the like (in a so-called full-like inkjet printer with an ink ejection head having the same width as the maximum print width), the positions at which inks are dropped could be displaced as a result of, for example, an exchange of a recording head and vibration during a transportation of the apparatus. To solve this issue, a registration adjustment that detects the displacement and adjusts, for example, an ejection timing of the recording head on the basis of the detected displacement is executed (hereinafter simply referred to as a registration adjustment). Japanese Patent Laid-Open No. 2011-170318 discloses a method that reads a printed material obtained by displacing a printed area in which transparent toner and colored toner overlap each other, in a stepwise manner, from a printed area in which they do not overlap each other, calculates a registration displacement amount of the transparent toner from density values of the printed material, and makes a correction.

However, there are cases where the conventional method cannot make the registration adjustment with high accuracy.

### SUMMARY OF THE INVENTION

The present invention provides a technique to execute processing for adjusting a displacement between a recording position of an ink for forming a three-dimensional image and a recording position of a color ink with high accuracy.

According to the first aspect of the present disclosure, there is provided a control apparatus, comprising: a print control unit configured to cause a pattern image to be printed on a print medium with use of a first recording material for forming a three-dimensional image and a colored second recording material, the pattern image including a print region of the first recording material and a print region of the second recording material that overlap with, or are displaced from, each other; and a processing unit configured to execute processing for adjusting a displacement between a recording position of the first recording material and a recording position of the second recording material.

According to the second aspect of the present disclosure, there is provided a non-transitory computer-readable storage medium storing a program for causing a computer to function as: a print control unit configured to cause a pattern image to be printed on a print medium with use of a first recording material for forming a three-dimensional image and a colored second recording material, the pattern image including a print region of the first recording material and a print region of the second recording material that overlap with, or are displaced from, each other; and a processing unit configured to execute processing for adjusting a displacement between a recording position of the first recording material and a recording position of the second recording material.

According to the third aspect of the present disclosure, there is provided a control method for a control apparatus, the control method comprising: causing a pattern image to be printed on a print medium with use of a first recording material for forming a three-dimensional image and a colored second recording material, the pattern image including a print region of the first recording material and a print region of the second recording material that overlap with, or are displaced from, each other; and executing processing for adjusting a displacement between a recording position of the first recording material and a recording position of the second recording material.

Further features of the present invention will become apparent from the following description of exemplary embodiments with reference to the attached drawings.

### BRIEF DESCRIPTION OF THE DRAWINGS

FIG. 1 is a diagram showing an exemplary configuration of an image forming system.

FIG. 2 is a block diagram showing an exemplary control configuration of an image forming system 200.

FIG. 3 is a diagram schematically showing examples of a medium equipped with a foam layer and a foam accelerator ink.

FIG. 4 is a flowchart of operations of the image forming system 200.

FIG. 5 is a flowchart showing the details of processing in step S401.

FIG. 6 is a flowchart showing the details of processing in step S402.

FIG. 7A is a diagram showing an example of a pattern image for a foam accelerator ink registration adjustment.

FIG. 7B is a diagram showing an example of a pattern image for a foam accelerator ink registration adjustment.

FIG. 8 is a diagram showing an exemplary configuration of a UI screen.

FIG. 9A is a diagram showing another example of a pattern image for a foam accelerator ink registration adjustment.

FIG. 9B is a diagram showing still another example of a pattern image for a foam accelerator ink registration adjustment.

FIG. 10 is a flowchart showing the details of processing in step S402.

FIG. 11 is a flowchart of processing executed by an image forming apparatus 100 in a case where a medium equipped with a foam layer has been loaded in this image forming apparatus 100.

FIG. 12 is a flowchart of operations of the image forming apparatus 100.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

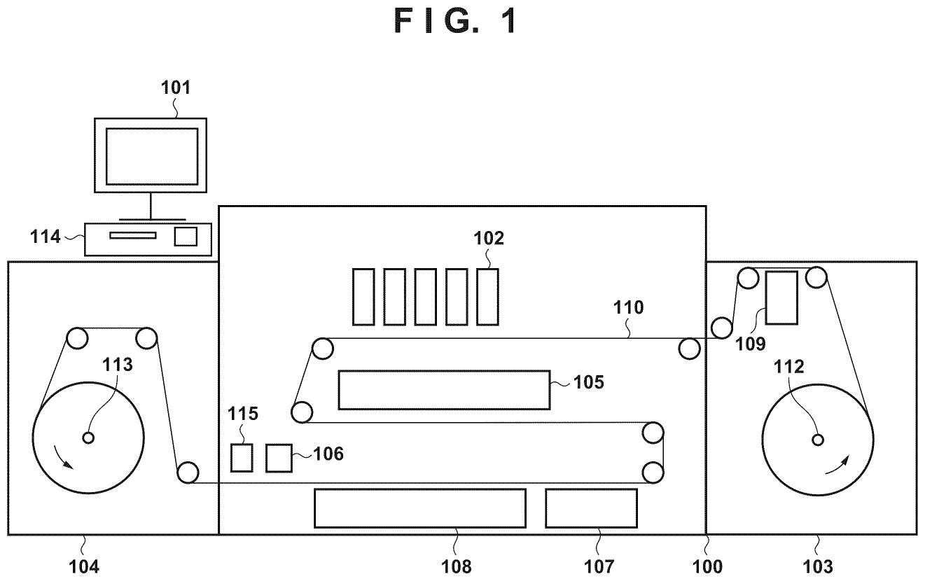

First, using FIG. 1, a description is given of an exemplary configuration of an image forming system including an image forming apparatus capable of forming images (including characters) and foam portions on a print medium, such as paper, with use of a foam accelerator ink that is one example of a first recording material, and a color ink that is one example of a second recording material. The image forming system according to the present embodiment is an image forming system that forms images/foam portions on continuous paper (hereinafter referred to as roll paper) on which continuous formation of images/foam portions is possible. As shown in FIG. 1, the image forming system according to the present embodiment includes a paper feeding apparatus 103, an image forming apparatus 100, a paper discharge apparatus 104, a control personal computer (PC) 114, and a user interface (UI) operation panel 101.

First, the paper feeding apparatus 103 will be described. The paper feeding apparatus 103 is an apparatus that supplies roll paper 110 to the image forming apparatus 100. The paper feeding apparatus 103 conveys the roll paper 110, which is wound around a paper core, at a constant speed toward the image forming apparatus 100 via an oblique light correction apparatus 109 and a plurality of rollers (conveyance rollers, paper feeding rollers, etc.) by causing the paper core of the roll paper 110 to rotate around a rotation shaft 112 in an arrow direction.

Next, the paper discharge apparatus 104 will be described. The paper discharge apparatus 104 is an apparatus that rolls up the roll paper 110, which has been conveyed from the image forming apparatus 100, in an arrow direction so that the roll paper 110 is in a rolled state around a paper core of the roll paper 110. In the paper discharge apparatus 104, for example, the roll paper 110 is held in a rolled state while being wound around the paper core on a rotation shaft 113 as shown in FIG. 1. The paper discharge apparatus 104 causes the paper core to rotate around the rotation shaft 113, thereby rolling up the roll paper 110 that has been conveyed to the paper core as a printed material at a constant speed via a plurality of rollers (e.g., conveyance rollers and paper discharge rollers).

Before printing is started, the roll paper 110 is guided into the paper discharge apparatus 104 from the paper feeding apparatus 103 through the image forming apparatus 100. First, the roll paper 110 is set in the paper feeding apparatus 103. Then, the leading edge of the roll paper 110 is guided above the oblique light correction apparatus 109, underneath an ink ejection head 102, underneath a drying apparatus 105, above cooling apparatuses 107 and 108, and underneath a color detection apparatus 106 and a height detection apparatus 115, and then wound around the paper core in the paper discharge apparatus 104.

Next, the image forming apparatus 100 will be described. The ink ejection head 102 includes an array of foam accelerator ink elements that ejects a foam accelerator ink, and an array of colored ink elements that ejects color inks of, for example, black (K), cyan (C), magenta (M), and yellow (Y), which are colored liquids containing color materials. The array of foam accelerator ink elements and the array of colored ink elements are arranged in parallel along the conveyance direction of the roll paper 110.

The drying apparatus 105 is disposed downstream relative to the ink ejection head 102 in the conveyance direction of the paper 110, and dries the roll paper 110 on which images and foam portions have been formed using the color inks and the foam accelerator ink. The cooling apparatus 107 and the cooling apparatus 108 are disposed downstream relative to the drying apparatus 105 in the conveyance direction of the roll paper 110, and cool the roll paper 110.

The color detection apparatus 106 is disposed downstream relative to the cooling apparatus 107 and the cooling apparatus 108 in the conveyance direction of the roll paper 110. For example, a color sensor facing the roll paper 110 is arranged in the color detection apparatus 106. Using the color sensor, the color detection apparatus 106 detects “a region of each color ink on the roll paper 110” as “a print region of a color ink”.

The height detection apparatus 115 is disposed downstream relative to the color detection apparatus 106 in the conveyance direction of the roll paper 110. For example, an ultrasound sensor facing the roll paper 110 is installed in the height detection apparatus 115. The height detection apparatus 115 detects the heights of projections on the roll paper 110 with use of the ultrasound sensor, and detects a region with a detected height equal to or larger than a prescribed value as “a region of a foam portion printed on the roll paper 110 using a foam accelerator ink (a print region of a foam accelerator ink)”.

Next, the control PC 114 will be described. The control PC 114 is a computer apparatus that executes processing corresponding to a user operation performed on the UI operation panel 101. For example, after the roll paper 110 has been guided into the image forming apparatus 100, if a user has further issued an instruction via a print start button displayed on the UI operation panel 101 following an input of a print job to the control PC 114 through the user's operation on the UI operation panel 101, the control PC 114 instructs the image forming apparatus 100 to start printing based on this print job. In response to this instruction, the image forming apparatus 100 forms images and foam portions on the roll paper 110 by controlling the paper feeding apparatus 103, the image forming apparatus 100, and the paper discharge apparatus 104.

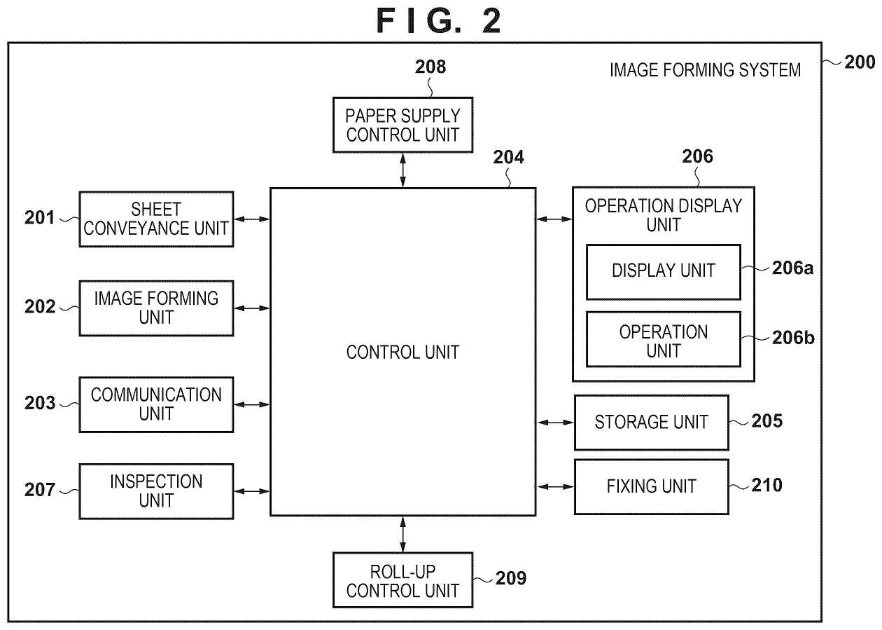

Next, an exemplary control configuration of an image forming system 200 according to the present embodiment will be described using a block diagram of FIG. 2. FIG. 2 shows a configuration related to formation of images and foam portions in the configuration shown in FIG. 1.

A sheet conveyance unit 201 is a conveyance mechanism for roll paper 111 inside the image forming apparatus 100. For example, the sheet conveyance unit 201 conveys the roll paper 111 conveyed from a paper supply control unit 208 to an image forming unit 202 with use of a plurality of rollers, and conveys the roll paper 111 that has passed through the image forming unit 202 to a roll-up control unit 209.

The image forming unit 202 forms images and foam portions on the roll paper 111 supplied from the paper supply control unit 208 by controlling the ink ejection head 102 on the basis of input print data.

A communication unit 203 includes, for example, a communication control card, such as a local area network (LAN) card, and exchanges various types of data with an external apparatus (e.g., a personal computer) connected to a communication network, such as a LAN and a wide area network (WAN).

A control unit 204 includes, for example, a processor like a central processing unit (CPU), a volatile memory such as a random-access memory (RAM), and the like. The processor executes various types of processing with use of computer programs and data stored in the volatile memory. In this way, the processor controls the operations of the entirety of the image forming system, and also executes or controls various types of processing that will be described as processing executed by the image forming system.

A storage unit 205 is, for example, a nonvolatile memory, such as a nonvolatile semiconductor memory (a so-called flash memory) and a hard disk drive (HDD). An operating system (OS), computer programs executed by the control unit 204 (various types of programs including a system program and a processing program), various types of data necessary for the execution of such computer programs, and so forth are saved in the storage unit 205. The computer programs and data saved in the storage unit 205 are loaded to the aforementioned volatile memory as appropriate under control of the control unit 204, and processed by the aforementioned processor. Note that the control unit 204 and the storage unit 205 may be apparatuses independent of the image forming apparatus 100 as long as a control apparatus and a storage apparatus are connected to the image forming apparatus 100.

An operation display unit 206 includes a display unit 206a and an operation unit 206b. The display unit 206a is, for example, a liquid crystal display (LCD) equipped with a touch panel. The display unit 206a displays the result of processing executed by the control unit 204 with use of images, characters, and the like, and also accepts an operation performed by the user on a screen displayed on this liquid crystal display (a user operation). The operation unit 206b includes various types of operation keys, such as numeric keys and a start key, and accepts various types of input operations performed by the user.

For example, the operation display unit 206 is operable by the user to set setting information related to a print job (settings of paper to be used, a printing speed, the number of sheets to be printed, the number of copies to be printed, a printing length, a printing weight, a printing diameter, etc.) when executing the print job.

An inspection unit 207 controls the aforementioned color detection apparatus 106 to detect “a print region of a color ink” with use of the color sensor. Also, the inspection unit 207 controls the aforementioned height detection apparatus 115 to detect the heights of projections on the roll paper 110 with use of the ultrasound sensor, and detect a region with a detected height equal to or larger than a prescribed value as “a print region of a foam accelerator ink”.

The paper supply control unit 208 supplies the roll paper 110 to the image forming apparatus 100 by controlling the operations of the paper feeding apparatus 103. The roll-up control unit 209 rolls up the roll paper 110 conveyed from the image forming apparatus 100 by controlling the operations of the paper discharge apparatus 104.

A fixing unit 210 controls the drying apparatus 105, the cooling apparatus 107, and the cooling apparatus 108 to dry, and then cool, the roll paper 110 on which images and foam portions have been formed using the color inks and the foam accelerator ink, thereby causing the images and the foam portions to be fixed on the roll paper 110.

The user operates an external apparatus to generate a print job, and also to input setting information of this print job (such setting information as paper to be used, a printing speed, the number of sheets to be printed, the number of copies to be printed, a printing length, a printing weight, a printing diameter, and the number of rolls to be delivered). Then, in response to the user operation, this external apparatus generates a job ticket including this print job and this print setting, and transmits this job ticket to the image forming system 200. The control unit 204 receives the job ticket transmitted from this external apparatus via the communication unit 203. Note that the setting information may be input through a user operation on the operation display unit 206.

Based on this job ticket, the image forming apparatus 100 controls the paper feeding apparatus 103 and the paper discharge apparatus 104 to cause the roll paper 110 to be conveyed and rolled up, and also to form images and foam portions on this roll paper 110.

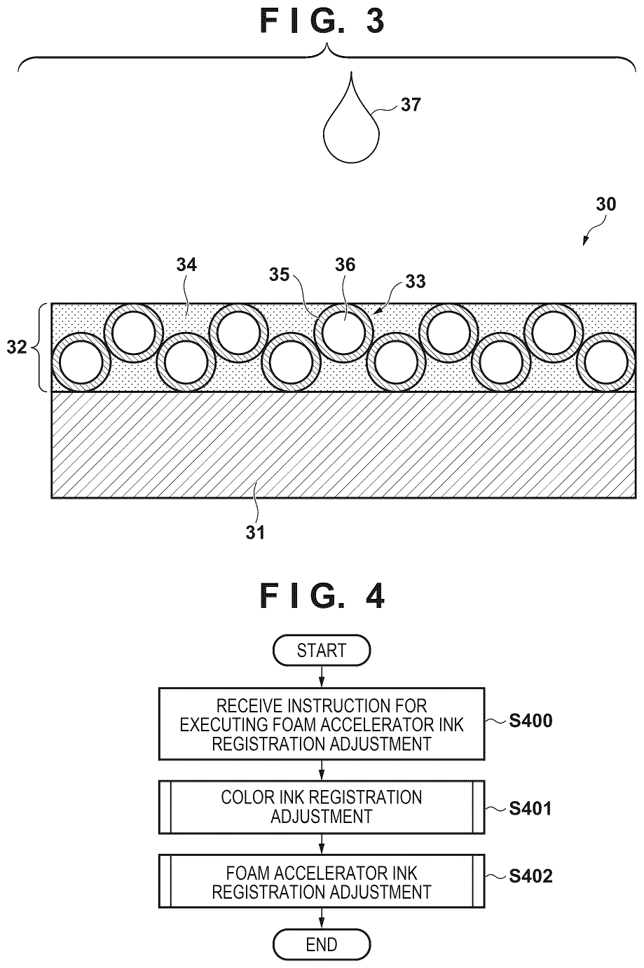

Next, a medium equipped with a foam layer and the foam accelerator ink will be described. FIG. 3 is a diagram schematically showing examples of a medium equipped with a foam layer and the foam accelerator ink. A medium 30 equipped with a foam layer includes a base material 31 and “a foam layer 32 containing foam particles 33 that foam with heat”, which is provided on the base material 31.

The base material 31 functions as a support member for supporting the foam layer 32. The type of the base material 31 is not limited in particular. For example, it may be: normal paper made from natural pulp; kenaf paper; a plastic film sheet made from polypropylene, polyethylene, polyester, or the like; so-called synthetic paper or non-woven fabric, which is quasi-paper made from synthetic fibers, synthetic pulp, or a synthetic resin film; and so forth. The foam layer 32 is a layer which is provided on at least one of the surfaces of the base material 31, and which contains the foam particles 33 and a binder resin 34. A foam particle 33 is a thermally expandable microcapsule including a capsule-like shell layer 35 containing a thermoplastic resin, and a volatile material 36 enclosed in this shell layer 35. When heat is applied to the foam particle 33, the thermoplastic resin composing the shell layer 35 softens, and the volatile material 36 enclosed in the shell layer 35 vaporizes and expands in volume. As a result, the foam particle 33 expands like a balloon.

Examples of the thermoplastic resin contained in the shell layer 35 can include polystyrene, a styrene-acrylic acid ester copolymer, a polyamide resin, polyacrylic acid ester, polyvinylidene chloride, polyacrylonitrile, polymethylmethacrylate, a vinylidene chloride/acrylonitrile copolymer, a methacrylic acid ester/acrylic acid copolymer, a vinylidene chloride/acrylic acid copolymer, a vinylidene chloride/acrylic acid ester copolymer, and so forth.

Examples of the volatile material 36 include a low-molecular-weight hydrocarbon like ethane, ethylene, propane, propene, n-butane, isobutane, n-pentane, isopentane, neopentane, n-hexane, heptane, and petroleum ether, a chlorofluorocarbon like CCl₃F, CCl₂F₂, CClF₃, and CClF₂ CClF₂, tetraalkylsilane like tetramethylsilane, ethyltrimethylsilane, trimethylisopropylsilane, and trimethyl-n-propylsilane, and so forth. Among these, the volatile material 36 can be a hydrocarbon with a molecular weight equal to or smaller than 120. Furthermore, although a lower limit of a molecular weight of the volatile material 36 (hydrocarbon) is not limited in particular, it can be equal to or larger than 50, for example. Using the total mass of the foam layer 32 as a reference, the amount of the foam particles 33 contained in the foam layer 32 can be equal to or larger than 5% by mass and equal to or smaller than 95% by mass.

The foam layer 32 contains the binder resin 34 to improve adhesion to the base material 31. The binder resin 34 plays a crucial role to suppress peeling of the foam layer 32 from the base material 31 when the foam particles 33 in the foam layer 32 have foamed with heat. As the binder resin 34 contains a water-insoluble resin, the binder resin 34 is not easily dissolved by water inside a foam accelerator ink 37; therefore, a decrease in adhesion between the foam layer 32 and the base material 31 caused by the foam accelerator ink 37 can be suppressed. In addition, even if water-based ink containing water has been applied to a recording medium, a decrease in adhesion between the foam layer 32 and the base material 31 can be suppressed for the same reason. The water-insoluble resin mentioned here denotes a resin that remains by 95% by mass or more when immersed in heated water of 80° C. for two hours. The water-insoluble resin can be at least one type selected from a group consisting of an acrylic resin and a urethane resin. Also, the water-insoluble resin can further be at least one type selected from a group consisting of an acrylic resin that does not have an ester group and a urethane resin that does not have an ester group. Furthermore, the water-insoluble resin can be a non-water-absorbent resin. Using the total mass of the foam layer 32 as a reference, the amount of the water-insoluble resin contained in the foam layer 32 can be equal to or larger than 10% by mass and equal to or smaller than 95% by mass. Moreover, the foam layer 32 may contain a water-soluble resin, together with a water-insoluble resin, as long as the effect of suppression of peeling of the foam layer 32 from the base material 31 can be achieved when the foam particles 33 in the foam layer 32 have foamed with heat. In addition, the glass-transition temperature of the binder resin 34 can be equal to or higher than −10° C. and equal to or lower than 30° C. By keeping the glass-transition temperature of the binder resin 34 within the foregoing range, interruption of foaming of the foam particles 33 by the binder resin 34 can be suppressed.

The mass ratio between the foam particles 33 and the binder resin 34 can be as follows: foam particles: binder resin=5:95 to 90:10. By keeping the mass ratio between the foam particles 33 and the binder resin 34 within the foregoing range, both the foamability of the foam particles 33 and the bonding performance of the binder resin 34 relative to the base material 31 can be improved. The foam layer 32 can further contain such components as pigments, an antioxidant, a dye, and surfactants as long as the foamability is not impaired.

The foam accelerator ink 37 contains a foam accelerator component that reduces the temperature at which foaming of the foam particles 33 is started. When the foam accelerator ink 37 containing the foam accelerator component has been applied to the foam layer 32, which is included in the medium 30 equipped with the foam layer 32, using such methods as inkjet ejection and coating, the thermoplastic resin contained in the shell layers 35 of the foam particles 33 can be softened. It is presumed that, as a result of this, the temperature at which foaming of the foam particles 33 is started and the maximum foaming temperature can be shifted to the low-temperature side.

It is sufficient that the foam accelerator component be a component that can soften the thermoplastic resin contained in the shell layers 35 of the foam particles 33, and be a chemical compound that does not have a hydroxy group, and this component/chemical compound can be selected and used as appropriate in accordance with, for example, the type of the thermoplastic resin. Examples of the foam accelerator component include 2-pyrrolidone, dimethyl sulfoxide, N,N-dimethylformamide, N-methyl-2-pyrrolidone, and so forth. The boiling point of the chemical compound that acts as the foam accelerator component and does not have a hydroxy group can be made higher than the temperature of heat applied to the foam layer 32. As the boiling point of this chemical compound is higher than the temperature of heat applied to the foam layer 32, this chemical compound does not easily vaporize even if heat is applied to the foam layer 32; this can contribute to softening of the thermoplastic resin in the shell layers 35 of the foam particles 33. Using the total mass of the foam accelerator ink 37 as a reference, the amount of the contained chemical compound that acts as the foam accelerator component and does not have a hydroxy group can be equal to or larger than 10% by mass and equal to or smaller than 70% by mass.

In the present embodiment, the image forming system 200 uses a foam accelerator ink and a color ink to print a pattern image, in which a print region of this foam accelerator ink is displaced from a print region of this color ink, on roll paper 110 that is a medium equipped with a foam layer, and then outputs the roll paper 110. The user checks the pattern image printed on this roll paper 110, and designates the amount of displacement between a recording position of the foam accelerator ink and a recording position of the color ink by operating the UI operation panel 101. Then, the image forming system 200 executes processing for adjusting the displacement between the recording position of the foam accelerator ink and the recording position of the color ink (a foam accelerator ink registration adjustment) on the basis of this designated amount of displacement. Such operations of the image forming system 200 will be described in accordance with a flowchart of FIG. 4.

In step S400, the control unit 204 obtains “an instruction for executing the foam accelerator ink registration adjustment” that has been input in response to a user operation. For example, the user inputs the instruction for executing the foam accelerator ink registration adjustment by operating the UI operation panel 101 or the operation display unit 206.

In step S401, a color ink registration adjustment is made under control of the control unit 204. The color ink registration adjustment is processing for adjusting the positions at which color inks are dropped. The details of processing in step S401 will be described later.

In step S402, the foam accelerator ink registration adjustment is made under control of the control unit 204. The foam accelerator ink registration adjustment is processing for adjusting the positions at which a color ink and a foam accelerator ink are dropped. The details of processing in step S402 will be described later.

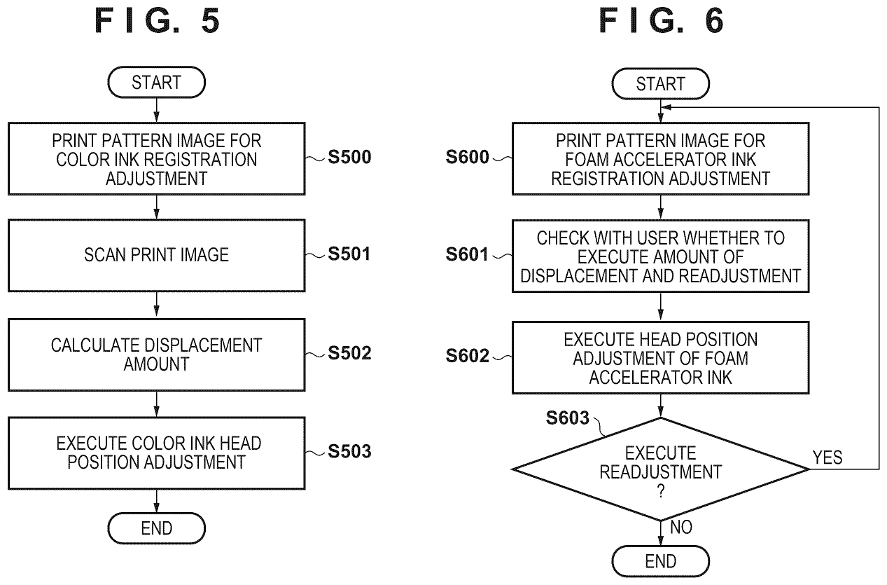

Next, the details of processing in the aforementioned step S401 will be described in accordance with a flowchart of FIG. 5. In step S500, the control unit 204 reads out a pattern image for a color ink registration adjustment saved in the storage unit 205. Then, the control unit 204 prints this pattern image for the color ink registration adjustment that has been read out on roll paper 110 by controlling the paper supply control unit 208, sheet conveyance unit 201, image forming unit 202, roll-up control unit 209, and fixing unit 210.

In step S501, under control of the control unit 204, the inspection unit 207 detects print regions of the respective color inks in the pattern image for the color ink registration adjustment that has been printed on the roll paper 110 in step S500.

In step S502, the control unit 204 calculates the amounts of displacements between the regions of the respective color inks in the pattern image for the color ink registration adjustment and the print regions of the color inks detected in step S501.

In step S503, the control unit 204 adjusts the head position of the color inks with use of the amounts of displacements that have been calculated for the respective color inks in step S502. As processing in step S503 is a known technique, a detailed description related to this processing is omitted.

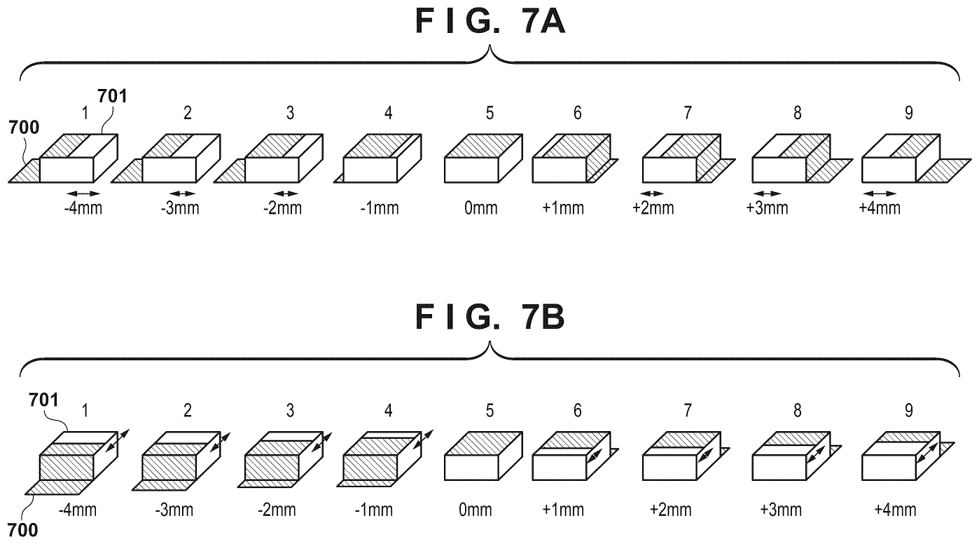

Next, the details of processing in the aforementioned step S402 will be described in accordance with a flowchart of FIG. 6. In step S600, the control unit 204 reads out a pattern image for a foam accelerator ink registration adjustment saved in the storage unit 205. FIG. 7A shows an example of the pattern image for the foam accelerator ink registration adjustment.

A region indicated by reference numeral 700 represents a print region printed using a color ink (a color ink print region), whereas a region indicated by reference numeral 701 represents a print region printed using a foam accelerator ink (a foam accelerator ink print region).

In the pattern image for the foam accelerator ink registration adjustment in FIG. 7A, nine foam accelerator ink print regions are aligned at an equal interval. Also, the positions of the first, second, third, and fourth color ink print regions from the left are displaced, toward the left, from the positions of the first, second, third, and fourth foam accelerator ink print regions from the left by 4 mm, 3 mm, 2 mm, and 1 mm, respectively. The position of the fifth color ink print region from the left is the same as the position of the fifth foam accelerator ink print region from the left. The positions of the sixth, seventh, eighth, and ninth color ink print regions from the left are displaced, toward the right, from the positions of the sixth, seventh, eighth, and ninth foam accelerator ink print regions from the left by 1 mm, 2 mm, 3 mm, and 4 mm, respectively.

The purpose of the pattern image for the foam accelerator ink registration adjustment is to cause the user to recognize a displacement between a print region of the color ink and a print region of the foam accelerator ink. Therefore, the number of the foam accelerator ink print regions and the color ink print regions, as well as the amount by which, are not limited to specific numerical values.

FIG. 7B shows another example of the pattern image for the foam accelerator ink registration adjustment. In the pattern image for the foam accelerator ink registration adjustment in FIG. 7B, nine foam accelerator ink print regions are aligned at an equal interval. Also, the positions of the first, second, third, and fourth color ink print regions from the left are displaced, toward the front, from the positions of the first, second, third, and fourth foam accelerator ink print regions from the left by 4 mm, 3 mm, 2 mm, and 1 mm, respectively. The position of the fifth color ink print region from the left is the same as the position of the fifth foam accelerator ink print region from the left. The positions of the sixth, seventh, eighth, and ninth color ink print regions from the left are displaced, toward the back, from the positions of the sixth, seventh, eighth, and ninth foam accelerator ink print regions from the left by 1 mm, 2 mm, 3 mm, and 4 mm, respectively.

In both of the pattern image for the foam accelerator ink registration adjustment in FIG. 7A and the pattern image for the foam accelerator ink registration adjustment in FIG. 7B, unique numbers 1 to 9 are assigned to the foam accelerator ink print regions/color ink print regions, respectively. Note that items other than numbers may be assigned as long as they allow each foam accelerator ink print region/color ink print region to be identified. Furthermore, the direction in which a color ink print region is displaced is not limited to toward the left and right (the x direction) only, or toward the front and back (the y direction) only, and may be a combination of directions toward the left, right, front, and back.

Then, the control unit 204 prints this pattern image for the foam accelerator ink registration adjustment that has been read out on roll paper 110 by controlling the paper supply control unit 208, sheet conveyance unit 201, image forming unit 202, roll-up control unit 209, and fixing unit 210 (print control). Note that, in the pattern image for the foam accelerator ink registration adjustment, the image forming apparatus 100 prints images (foam portions) in the foam accelerator ink print regions with use of the foam accelerator ink, and thereafter prints images in the color ink print regions with use of the color ink.

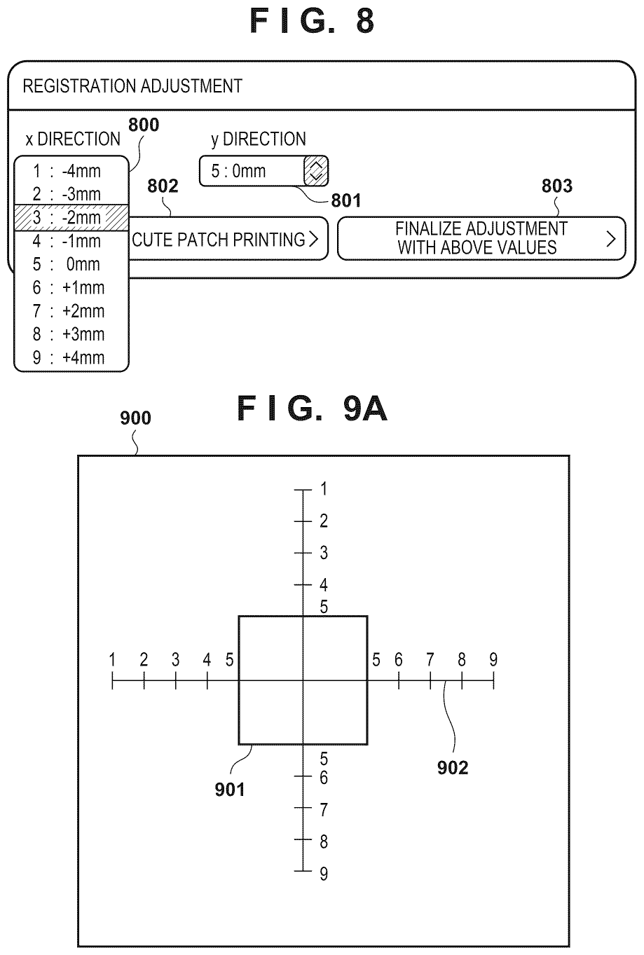

In step S601, the control unit 204 controls the control PC 114 to cause the UI operation panel 101 to display a UI screen exemplarily shown in FIG. 8. When the user has performed an operation for displaying options for a displacement amount of the foam accelerator ink print region in the x direction on the UI screen, a list 800, which includes a listing of these options, is displayed; accordingly, the user can select a desired displacement amount from this listing. Also, when the user has issued an instruction via a region 801 on the UI screen, a list including a listing of options for a displacement amount of the foam accelerator ink print region in the y direction is displayed; accordingly, the user can select a desired displacement amount from this listing. Note that a method of designating a displacement amount is not limited to a specific method; for example, the user may directly input a numerical value indicating a displacement amount.

A button 802 is a button for issuing an instruction for printing the pattern image for making an adjustment again, and a button 803 is a button for issuing an instruction for processing to end the registration adjustment after the head position of the foam accelerator ink is adjusted using the displacement amount set on the present UI screen.

When the user has issued an instruction via the button 802 or the button 803 by operating the UI operation panel 101, processing proceeds to step S602. In step S602, the control unit 204 adjusts the head position of the foam accelerator ink with use of the displacement amount that has been set in response to a user operation on the above-described UI screen. As the adjustment of the head position of the foam accelerator ink is a known technique, a detailed description related to this processing is omitted.

In step S603, the control unit 204 determines whether an instruction has been issued via the button 802. In a case where the result of this determination indicates that an instruction has been issued via the button 802, processing proceeds to step S600; in a case where the result indicates that no instruction has been issued via the button 802, processing according to the flowchart of FIG. 6 ends.

The present embodiment has been described in relation to one example of a configuration that uses a first recording material for forming a three-dimensional image and a colored second recording material to print a pattern image, in which a print region of this first recording material is displaced from a print region of this second recording material, on a print medium, and that executes processing for adjusting a displacement between a recording position of the first recording material and a recording position of the second recording material in accordance with an adjustment amount designated in response to a user operation based on this print medium.

### Modification Example

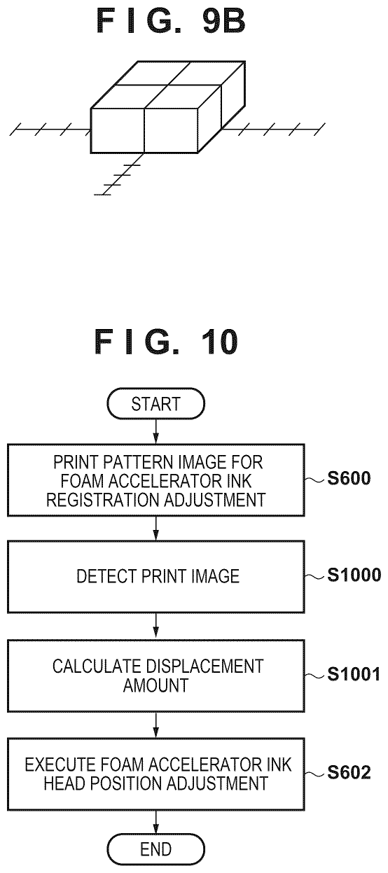

FIG. 9A shows still another example of the pattern image for the foam accelerator ink registration adjustment. In a pattern image 900 for a foam accelerator ink registration adjustment, a region 901 is a foam accelerator ink print region. Furthermore, in the pattern image 900 for the foam accelerator ink registration adjustment, a scale marking 902 is a color ink print region arranged at a position that overlaps with the region 901, and indicates indices of positions that are displaced from the origin, which is the center of the region 901, in the vertical direction and the horizontal direction. Note that the indices are not limited to numerical values, and any information may be used in place of the scale marking 902 as long as it is information indicating positions that are displaced from the origin, which is the center of the region 901, in the vertical direction and/or the horizontal direction. FIG. 9B is a diagram showing the pattern image for the foam accelerator ink registration adjustment of FIG. 9A as viewed obliquely from above.

### Second Embodiment

The differences from the first embodiment will be described in each of the following embodiments, including the present embodiment, and it is assumed that the following embodiments are similar to the first embodiment unless specifically stated otherwise below. In the first embodiment, the head position of the foam accelerator ink is adjusted using a displacement amount designated by a user. In contrast, in the present embodiment, a displacement amount is calculated from the result of printing of a pattern image for a foam accelerator ink registration adjustment without a user operation, and the head position of the foam accelerator ink is adjusted using this calculated displacement amount.

In the present embodiment, processing according to a flowchart of FIG. 10 is executed in the aforementioned step S402. In FIG. 10, processing steps similar to processing steps shown in FIG. 6 are assigned the same step numbers thereas, and a description related to such processing steps is omitted.

In step S1000, the inspection unit 207 controls the color detection apparatus 106 to detect “a print region of a color ink” formed in printing of step S600 from roll paper 110 with use of the color sensor. Also, the inspection unit 207 controls the height detection apparatus 115 to detect the heights of projections on this roll paper 110 with use of the ultrasound sensor, and detect a region with a detected height equal to or larger than a prescribed value as “a print region of the foam accelerator ink”.

In step S1001, the control unit 204 calculates the difference between the positions of “the print region of the color ink” detected in step S1000 and “the print region of the foam accelerator ink” detected in step S1000 as a displacement amount. In step S602, the control unit 204 adjusts the head position of the foam accelerator ink with use of the displacement amount calculated in step S1001, similarly to the first embodiment.

### Third Embodiment

Processing executed by the image forming apparatus 100 in a case where a medium equipped with a foam layer has been loaded in the image forming apparatus 100 will be described in accordance with a flowchart of FIG. 11. In FIG. 11, processing steps similar to processing steps shown in FIG. 4 are assigned the same step numbers thereas, and a description related to such processing steps is omitted.

In step S1100, the control unit 204 causes the UI operation panel 101 to display a screen intended for a user to select whether to execute a foam accelerator ink registration adjustment. In step S1101, in a case where the control unit 204 has detected a user operation performed on this screen and this user operation is inputting of an instruction for executing the foam accelerator ink registration adjustment, processing proceeds to step S401. On the other hand, in a case where the control unit 204 has detected a user operation performed on this screen and this user operation is not inputting of an instruction for executing the foam accelerator ink registration adjustment, processing according to the flowchart of FIG. 11 ends.

### Fourth Embodiment

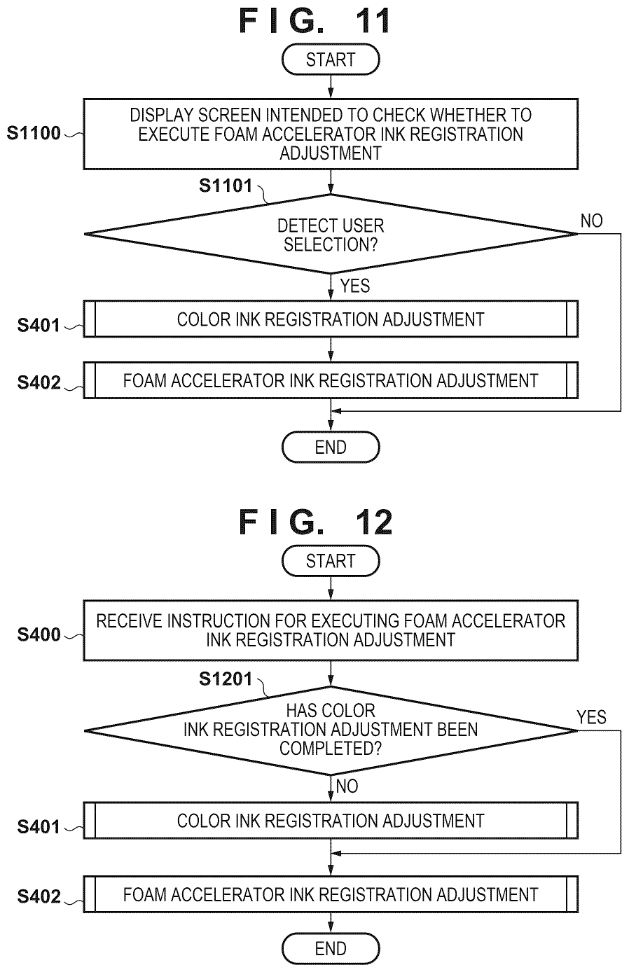

The operations of the image forming apparatus 100 according to the present embodiment will be described in accordance with a flowchart of FIG. 12. In FIG. 12, processing steps similar to processing steps shown in FIG. 4 are assigned the same step numbers thereas, and a description related to such processing steps is omitted.

In step S1201, the control unit 204 determines whether an execution history indicating that a color ink registration adjustment has been executed is stored in the storage unit 205. In a case where the result of this determination indicates that an execution history indicating that a color ink registration adjustment has been executed is stored in the storage unit 205, processing skips step S401 and proceeds to step S402. On the other hand, in a case where the result of this determination indicates that an execution history indicating that a color ink registration adjustment has been executed is not stored in the storage unit 205, processing proceeds to step S401. Note that in the present embodiment, in processing of step S401, the control unit 204 stores an execution history indicating that a color ink registration adjustment has been executed into the storage unit 205.

Note that in step S401, the control unit 204 may store the execution history into the storage unit 205 together with a timestamp indicating the current date and time. In this case, even in a case where it is determined that an execution history is stored in the storage unit 205 in step S1201, processing proceeds to step S401 if an elapsed time period between the date and time indicated by a timestamp of this execution history and the current date and time is equal to or longer than a prescribed time period. On the other hand, if the elapsed time period between the date and time indicated by the timestamp of the execution history that has been determined to be stored in the storage unit 205 in step S1201 and the current date and time is shorter than the prescribed time period, processing skips step S401 and proceeds to step S402. Note that in a case where it is determined that an execution history is not stored in the storage unit 205 in step S1201, processing proceeds to step S401.

Note that although each of the above embodiments has been described using an example in which a three-dimensional image is formed using a foam accelerator ink and a medium having a foam layer, a method of forming a three-dimensional image is not limited to this example. For example, a three-dimensional image may be formed using inks that cure with light, such as ultraviolet rays, or heat. Furthermore, an electrophotographic method that uses toner may be adopted instead of an inkjet recording method.

The numerical values, the processing timings, the order of processing, the executors of processing, the configuration/obtainment method/transmission destination/transmission source/storage location of data (information), and the like used in the above embodiments are presented as examples to provide a specific description, and a limitation to these examples is not intended.

Also, parts or all of the above-described embodiments may be used in combination as appropriate. Furthermore, parts or all of the above-described embodiments may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074510, filed May 1, 2024, which is hereby incorporated by reference herein in its entirety.

What is claimed is:

1. A control apparatus, comprising:
a print control unit configured to cause a pattern image to be printed on a print medium with use of a first recording material for forming a three-dimensional image and a colored second recording material, the pattern image including a print region of the first recording material and a print region of the second recording material that overlap with, or are displaced from, each other; and
a processing unit configured to execute processing for adjusting a displacement between a recording position of the first recording material and a recording position of the second recording material.

2. The control apparatus according to claim 1, wherein
the print control unit causes a pattern image to be printed on a print medium, the pattern image including print regions of the second recording material and print regions of the first recording material that are displaced from each other by different displacement amounts.

3. The control apparatus according to claim 1, wherein
the print control unit causes a pattern image to be printed on a print medium, the pattern image including a print region of the first recording material and a print region of the second recording material, the print region of the second recording material being information indicating each position of displacement, in a vertical direction and/or a horizontal direction, from an origin represented by a center of the print region of the first recording material.

4. The control apparatus according to claim 1, wherein
the processing unit executes the processing in accordance with an adjustment amount designated in response to a user operation.

5. The control apparatus according to claim 1, wherein
the processing unit executes the processing in accordance with an amount of a displacement between the print region of the first recording material and the print region of the second recording material, the amount of the displacement having been read from the print medium.

6. The control apparatus according to claim 1, wherein
the print control unit and the processing unit operate in a case where a medium equipped with a foam layer has been loaded in an image forming apparatus and an instruction for executing the processing has been input in response to a user operation.

7. The control apparatus according to claim 1, wherein
a head position of the second recording material is adjusted before the printing.

8. The control apparatus according to claim 1, further comprising
a control unit configured to control an adjustment of a head position of the second recording material in accordance with an execution history of the adjustment of the head position of the second recording material.

9. The control apparatus according to claim 8, wherein
the control unit does not adjust the head position of the second recording material in a case where the execution history has been stored, and adjusts the head position of the second recording material in a case where the execution history has not been stored.

10. The control apparatus according to claim 8, wherein
the control unit does not adjust the head position of the second recording material in a case where an elapsed time period between a date and time indicated by a timestamp of the execution history and a current date and time is shorter than a prescribed time period, and adjusts the head position of the second recording material in a case where the elapsed time period is equal to or longer than the prescribed time period.

11. The control apparatus according to claim 1, wherein
the first recording material is a foam accelerator ink, and the second recording material is a color ink.

12. The control apparatus according to claim 1, wherein
the first recording material is an ink that cures with ultraviolet rays, and the second recording material is a color ink.

13. A non-transitory computer-readable storage medium storing a program for causing a computer to function as:
a print control unit configured to cause a pattern image to be printed on a print medium with use of a first recording material for forming a three-dimensional image and a colored second recording material, the pattern image including a print region of the first recording material and a print region of the second recording material that overlap with, or are displaced from, each other; and
a processing unit configured to execute processing for adjusting a displacement between a recording position of the first recording material and a recording position of the second recording material.

14. A control method for a control apparatus, the control method comprising:
causing a pattern image to be printed on a print medium with use of a first recording material for forming a three-dimensional image and a colored second recording material, the pattern image including a print region of the first recording material and a print region of the second recording material that overlap with, or are displaced from, each other; and
executing processing for adjusting a displacement between a recording position of the first recording material and a recording position of the second recording material.
